(19) United States
(12) Patent Application Publication
(10) Pub. No.: US 2024/0158988 A1
(43) Pub. Date: May 16, 2024

(54) RECYCLABLE AND REUSABLE POLLEN PAPER

(71) Applicant: Nanyang Technological University, Singapore (SG)

(72) Inventors: Nam-Joon CHO, Singapore (SG); Ze ZHAO, Singapore (SG); Subra SURESH, Singapore (SG)

(21) Appl. No.: 18/281,417

(22) PCT Filed: Mar. 16, 2022
(86) PCT No.: PCT/SG2022/050141

§ 371 Date: Sep. 11, 2023

(30) Foreign Application Priority Data
Mar. 16, 2021 (SG) 10202102664T
Sep. 20, 2021 (SG) 10202110353Y

(51) Int. Cl. D21C 5/02; D21H 17/21; D21H 25/02

(52) U.S. Cl. CPC D21C 5/027; D21H 17/21; D21H 25/02

(57) ABSTRACT

A pollen paper formed from a plurality of pollen microgels, which paper is dimensionally locked for use in the generation of conventional printed matter. It is possible to remove the printed subject matter from the pollen paper by a process that involves immersing the pollen paper into an alkaline bath, then removing the water through immersing it in a dehydrating bath and finally dimensionally locking the paper by immersing it in an acidic bath.

### FIELD OF INVENTION

This invention relates to a paper formed from pollen microgels which can be used in the same manner as conventional wood-pulp paper for printing upon, but which can be conveniently reused by use of a simple recycling method.

### BACKGROUND

The listing or discussion of a prior-published document in this specification should not necessarily be taken as an acknowledgement that the document is part of the state of the art or is common general knowledge.

Paperless digital technologies are gaining greater adoption for both personal and business communications and commerce, with their widespread global appeal significantly accelerated by increased digitization especially since the onset of the global pandemic in early 2020. However, paper remains one of the most widely used materials in the world. Ink printed on paper continues to be the most trusted form of encoding information for security, authenticity, long-term archival storage, and permanence that digital text cannot provide. Consequently, paper production and use remain an important issue of material science, especially when it comes to the sustainable use of natural resources.

Although the basic composition of wood-derived paper (i.e., cellulose fiber) is renewable, modern industrial papermaking is a multi-step process with severe and often deleterious environmental impact. The pulp and paper industry consumes substantial natural resources (e.g., wood and water) and energy, and produces waste (e.g., chemicals). In the last 20 years, energy use by the pulp and paper industry grew by an average of 0.3% annually, while the paper and paperboard output increased by 1.4%, according to the International Energy Agency (I. E. Agency, IEA, 2020). Conventional paper production also entails the generation of greenhouse gases (GHGs), effluents, and emissions, and causes deforestation and irreversible environmental pollution, thereby contributing to global warming. To achieve carbon neutrality, much effort needs to be channeled toward paper recycling; however, the processes involved in conventional paper recycling, including repulping, de-toning, and reconstruction, are some of the most significant contributors to energy consumption, toxic chemical release, and GHG emissions.

In recent years, the concept of “unprinting,” which entails removing the toner from printed paper while keeping the paper intact, has been proposed as an alternative to de-toning because it does not require pulping (D. R. Leal-Ayala, J. M. Allwood & T. A. M. Counsell, Appl. Phys. A 2011, 105, 801). The real and in situ reuse of waste paper can be achieved through unprinting while reducing GHG emissions. Several pathways to achieve unprinting have been developed (T. A. M. Counsell & J. M. Allwood, J. Mater. Process. Technol. 2006, 173, 111). Considering that toner is a plastic substance, organic chemicals such as chloroform, dimethylsulfoxide, and acetone have been adopted to weaken the bond between the paper and the toner. Applying these chemicals, the toner material is removed from wood-based paper through physical decohesion or oscillation (U.S. Pat. No. 6,236,831B1). However, the use of organic chemicals poses environmental and health risks, and the mechanical erasure of the toner may damage the physical integrity of paper (U.S. Pat. No. 6,128,464A).

In the optical unprinting approach, in which a laser or xenon lamp with high-intensity light output is applied to ablate the toner off the printed paper, the dependence on chemical use is minimized, but the mechanical integrity of the paper could still be damaged (M. Dexter et al., J. Cleaner Prod. 2019, 232, 274; and D. R. Leal-Ayala et al., Proc. R. Soc. London, Ser. A 2012, 468, 2272). Additionally, xenon lamps have shown a lower removal rate for light-colored toners than black toner, further limiting their practical utility (M. Dexter et al., J. Cleaner Prod. 2019, 232, 274). Given the natural inertness of both cellulose and toner to green solvents, mechanical separation between the paper and toner may be the most promising de-toning approach; however, such mechanical peeling of the toner could break the cellulose fibers, thereby impairing the reuse of the recycled paper.

Therefore, there exists a need to find a sustainably printable paper that can be nondestructively and mechanically recycled without using environmentally unfriendly chemicals or optical interventions.

### SUMMARY OF INVENTION

It has been surprisingly found that one or more of the problems identified above can be solved through the use of a pollen paper that can be recycled and reused multiple times using a simple process that does not require significant amounts of energy input. It has also been surprisingly found that pollen papers of the like disclosed herein can be “set” via a facile acid treatment, such that they do not significantly respond to changes in humidity. This has an advantage in allowing the acid-treated pollen papers disclosed herein to be used for printing in the first place—without fear that the text/images will degrade due to changes in the size of the pollen paper due to changes in the relative humidity of the ambient environment.

Aspects and embodiments of the invention will now be described below by reference to the following numbered clauses.

1. A method of recycling a pollen paper, comprising:
(a) providing a pollen paper that has been printed upon by a toner and/or an ink and immersing it in an aqueous solution having a pH of from 6 to 14 with mechanical agitation for a first period of time to remove the toner and/or ink and provide a swollen pollen paper;
(b) placing the swollen pollen paper into a dehydrating solvent for a second period of time to provide a dehydrated pollen paper; and
(c) subjecting the dehydrated pollen paper to an acidic solution for a third period of time and then drying it to provide a hygro-stable pollen paper suitable for use in a printer.

2. The method according to Clause 1, wherein the aqueous solution is an alkaline solution, optionally wherein the pH of the alkaline solution is from 9 to 14, optionally wherein the pH is from 10 to 12.

3. The method according to Clause 1 or Clause 2, wherein the first period of time is from seconds to 1 hour, such as from 30 seconds to 10 minutes, such as from 1 minute to 5 minutes, such as about 2 minutes.

4. The method according to any one of the preceding clauses, wherein the dehydrating solvent is an alcohol, optionally wherein the alcohol is selected from one or more of the group consisting of methanol, ethanol, n-propanol, and i-propanol (e.g. the dehydrating solvent is ethanol).

5. The method according to any one of the preceding clauses, wherein the second period of time is from 10 seconds to 1 hour, such as from 30 seconds to 10 minutes, such as from 1 minute to 10 minutes, such as about 5 minutes.

6. The method according to any one of the preceding clauses, wherein the pH of the acidic solution is from 1 to 5, optionally wherein the pH is from 3 to 4.

7. The method according to any one of the preceding clauses, wherein the third period of time is from 1 minute to 7 days, such as from 10 minutes to 3 days, such as from 1 hour to 60 hours, such as about 48 hours.

8. The method according to any one of the preceding clauses, wherein the hygro-stable pollen paper shows a unidimensional swelling ratio of less than or equal to 5% when immersed in water having a pH of about 7 for 5 minutes.

9. The method according to any one of the preceding clauses, wherein after step (b) and before step (c) of Clause 1, the pollen paper is dried to provide a dried pollen paper.

10. The method according to any one of the preceding clauses, wherein the pollen paper provided in step (a) of Clause 1 comprises a plurality of pollen microgels, where:
(AA) when the pollen paper provided in step (a) of Clause 1 is a hygro-stable pollen paper, it shows a unidimensional swelling ratio of less than or equal to 5% when immersed in water having a pH of about 7 for 5 minutes; or
(AB) when the pollen paper provided in step (a) of Clause 1 is a hygro-instable pollen paper, it shows a unidimensional swelling ratio of greater than or equal to 25% when immersed in water having a pH of about 7 for 5 minutes.

11. The method according to Clause 10(AA), wherein when the pollen paper is a hygro-stable pollen paper, each of the plurality of pollen microgels has a surface that comprises a plurality of carboxylic acid functional groups, where substantially all of the carboxylic acid functional groups are in the protonated (CO₂H) form.

12. A hygro-stable pollen paper, comprising a plurality of pollen microgels, wherein the hygro-stable pollen paper shows a unidimensional swelling ratio of less than or equal to 5% when immersed in water having a pH of about 7 for 5 minutes.

13. The hygro-stable pollen paper according to Clause 12, wherein each of the plurality of pollen microgels has a surface that comprises a plurality of carboxylic acid functional groups, where substantially all of the carboxylic acid functional groups are in the protonated (CO₂H) form.

14. A method of forming a hygro-stable pollen paper, the method comprising the steps of:
(ai) providing a pollen paper; and
(aii) subjecting the pollen paper to an acidic solution for a period of time and then drying it to provide a hygro-stable pollen paper.

15. The method according to Clause 14, wherein the pH of the acidic solution is from 1 to 5, optionally wherein the pH is from 3 to 4.

16. The method according to Clause 14 or Clause 15, wherein the period of time is from 1 minute to 7 days, such as from 10 minutes to 3 days, such as from 1 hour to 60 hours, such as about 48 hours.

17. The method according to any one of Clauses 14 to 16, wherein the hygro-stable pollen paper shows a unidimensional swelling ratio of less than or equal to 5% when immersed in water having a pH of about 7 for 5 minutes.

### DRAWINGS

FIG. 1 depicts the process of making pollen paper from raw pollen grains. a) Overview of sustainable processing methods used to prepare pollen papers compared to conventional processing methods used to prepare wood-based papers; b) Raw sunflower pollen grain collected by bees; and c) A large piece of fabricated pollen paper.

FIG. 2 depicts a photograph showing the drying process of the pollen microgels in a big square petri dish as the casting mold.

FIG. 3 depicts the haze effect of the pollen paper increased as the spacing between the pollen paper and the background images became larger.

FIG. 4 depicts top-view SEM images of the pollen paper at (a) low and (b) high magnifications. The scale bar in (a) and (b) is 10 μm and 1 μm, respectively.

FIG. 5 depicts the acid-mediated hygro-stability enhancement of pollen paper for preserving printed content. a) Schematic representation of proposed pH-dependent effect on the interaction of functional groups on pollen paper; b) Variation of the unidimensional swelling ratio of the pollen papers as a function of the immersion solutions' pH values; c, d) Uniaxial strain change of pollen papers with and without acid treatment upon exposure to relative humidity (RH) of c) 30% and d) 90%, as a function of time; e) Comparison of the deionised (DI)-water-induced unidimensional swelling ratios between the original and acid-treated pollen paper; f) A painting from the Sunflowers series by Vincent van Gogh (left) was digitally printed on an acid-treated pollen paper with toner (middle, the scale bar is 2 cm), together with a close-up optical microphotograph of the printed pollen paper (right, the scale bar is 0.5 mm); g) The printed pollen paper was submerged into DI water for 1 min to show its enhanced hygro-stability; and h) The Comparison of the appearances between wood-based paper and pollen-based paper printed with the same image.

FIG. 6 depicts the unidimensional swelling ratio of original pollen paper against time during the acidic solution immersion, followed by a final step of air-drying.

FIG. 7 depicts the size of acid-treated pollen paper had no apparent change in response to DI water.

FIG. 8 depicts the cyclical testing of the swelling of acid-treated pollen paper during ten hydration-dehydration cycles.

FIG. 9 depicts the mirror images of a printed painting shown on the acid-treated pollen paper due to its transparency. a) The digital version of a painting of sunflowers to be printed; b) Top view of a pollen paper printed with the painting; and c) Bottom view of a pollen paper printed with the painting. Scale bars are 1 cm.

FIG. 10 depicts the printing of pollen paper with toner. a) A photograph of a printed pollen paper (left), together with a close-up optical microphotograph (middle, scale bar is 0.5 mm) and an SEM image (right, scale bar is 20 μm) to show the top view of the printed toner pattern; and b) Cross-sectional-view SEM image of the printed pollen. The scale bar is 10 μm.

FIG. 11 depicts a, b) top-view SEM images of the printed acid-treated pollen paper at a) low and b) high magnifications. The scale bars in a) and b) are 20 μm and 2 μm, respectively; and c, d) Cross-sectional SEM images of the printed acid-treated pollen paper at c) low and d) high magnifications. The scale bars in c) and d) are 10 μm and 2 μm, respectively.

FIG. 12 depicts the appearance of an acid-treated pollen paper printed with a “Sunflowers” image that was stored under RH of a) 30%; and b) 90% for 24 h, respectively. The room RH level was 60%.

FIG. 13 depicts a time-lapse series of images to show the behavior of a printed wood-based office paper sheet that was submerged in DI water for 1 min.

FIG. 14 depicts the erasure of the pollen paper printed with toner, during immersion in basic solution. a) Swelling of the acid-treated pollen paper as a function of time when immersed in a solution of pH 12; b) Reversible change in pollen paper size in response to base-ethanol-drying treatment. Each cell in the background grid is 2.5 mm×2.5 mm; and c) The acid-treated pollen paper printed with the Sunflowers painting went through the base-ethanol-drying treatment for unprinting and in situ recycling.

FIG. 15 depicts the weight of pollen paper changes against time when it was submerged into DI water.

FIG. 16 depicts the unidimensional swelling rate at different treatment steps.

FIG. 17 depicts the weight of hydrated pollen paper over time after its transfer from basic solution to an ethanol bath followed by air-drying.

FIG. 18 depicts a) Top-view and b) cross-sectional SEM images of dry pollen paper; and c) Top-view and d) cross-sectional SEM images of swollen pollen paper. Scale bars are 10 μm.

FIG. 19 depicts the schematic illustration demonstrating printing and unprinting of the pollen paper and its in-situ recycling via swelling-induced toner unprinting.

FIG. 20 depicts the toner removal ratio of the pollen paper after the unprinting process.

FIG. 21 depicts the mechanism of the unprinting and subsequent in situ recycling of pollen paper. a) Schematic illustration to show the swelling-triggered toner removal for pollen paper recycling; and b) Microscopic top view of the toner-printed pollen paper to demonstrate the unprinting and recycling process. All scale bars are 200 μm.

FIG. 22 depicts the SEM images of toner-printed pollen paper a) before and b) after the unprinting and recycling process. Scale bars are 10 μm.

FIG. 23 depicts the unprinting and recycling of a digital-printed pollen paper with four primary colors: black, red, green, and blue.

FIG. 24 depicts the unprinting and recycling of a pollen paper sheet printed with black words with another laser printer model.

FIG. 25 depicts the re-printability of pollen paper. a) Cyclical testing of the swelling capacity of pollen paper during nine cycles of water-ethanol-drying treatment; b) Top-view SEM image of the surface of the dehydrated pollen paper after nine cycles of water-ethanol-drying treatment. The scale bar is 10 μm; and c) Multiple printing and unprinting of the same pollen paper with different images. The scale bar is 1 cm.

FIG. 26 depicts the recycling of the patterned original pollen paper. The recycling of a pollen paper, digitally toner-printed with a logo, demonstrating how the printed pattern could be erased completely through successive immersions in water and ethanol. The dotted frames with close-up micrographs show the same locations on the pollen paper prior to and following this recycling process. The scale bars are 1 cm.

FIG. 27 depicts the reversible change in volume of the pollen paper in response to water and ethanol. The size of each grid square is 2.5 mm by 2.5 mm.

FIG. 28 depicts the schematic illustration of how the pollen paper erases the printed toner layer and restores to the initially plain structure, in which water-induced dramatic swelling plays a key role.

### DESCRIPTION

In a first aspect of the invention, there is provided a method of recycling a pollen paper, comprising:
(a) providing a pollen paper that has been printed upon by a toner and/or an ink and immersing it in an aqueous solution having a pH of from 6 to 14 with mechanical agitation for a first period of time to remove the toner and/or ink and provide a swollen pollen paper;
(b) placing the swollen pollen paper into a dehydrating solvent for a second period of time to provide a dehydrated pollen paper; and
(c) subjecting the dried pollen paper to an acidic solution for a third period of time and then drying it to provide a hygro-stable pollen paper suitable for use in a printer.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

When referred to herein, the term “pollen paper” refers to a paper that has been manufactured from pollen grains from a suitable source (e.g. sunflower and/or commercial raw bee pollen). The process to make the pollen paper first involves defatting the pollen, which can then be mixed with a solution (e.g. 10% w/w) of KOH at an elevated temperature (e.g. about 80° C.) for a suitable period of time (e.g. about 5 hours) to produce soft pollen microgels. These soft pollen microgels can then be collected and washed, cast into a mold and then left to dry to produce a pollen paper comprising the soft pollen microgels, which has a microscopically rough surface topography, owing to the intrinsic nano- and microstructures of the self-assembled pollen grains. As will be appreciated, the dimensions of the paper are only limited by the casting mold used. It will be appreciated that any suitable pollen may be used to manufacture a pollen paper (e.g. sunflower pollen).

The pollen paper that has been printed upon by a toner and/or an ink may be in a hygro-stable form or not in a hygro-stable form. A pollen paper that has only undergone the process described above will not be in a hygro-stable form. Details of how to obtain a hygro-stable form of a pollen paper are provided hereinbelow.

Any suitable toner or ink used for printing on conventional paper may be applied to the pollen paper. As such, the pollen paper may be printed upon by any commercially available printer or copiers, such as a laser printer, a photocopier, an inkjet printer and the like.

As noted above, the process described herein relates to the unprinting of a pollen paper that has been printed upon by an ink or a toner (or both). The first step of this unprinting process involves subjecting the pollen paper that has been printed upon to immersion in an alkaline solution for a suitable period of time. This immersion causes the pollen paper to swell, which in turn leads to the detachment of the toner and/or ink on the surface of the pollen paper, particularly when the solution is subjected to some form of mechanical agitation. The pollen paper may swell by any suitable amount to achieve the desired denuding of the toner and/or ink from the surface of the paper. For example, the paper may swell from 20 to 60%, such as from 30 to 50%, such as about 40% of its original size (the original size being the size immediately before immersion in the alkaline solution). This results in the pollen paper substantially returning to its original state at the completion of the process, being free (or substantially free) of the toner and/or ink. The term “substantially free of the toner and/or ink” means that greater than 90% of the toner and/or ink are removed from the surface of the paper, such as greater than or equal to 95%, such as greater than or equal to 97%, such as greater than or equal to 98%, such as greater than or equal to 99%, such as greater than or equal to 99.5%, such as greater than or equal to 99.9%, such as greater than or equal to 99.99%.

As noted above, step (a) of the method described above may use an aqueous solution having a pH of from 6 to 14. This may allow a standard hygroscopic pollen paper to be used in the method to recycle and form a hygro-stable pollen paper. In such cases, the pH of the aqueous solution may be around a pH of 7 (e.g. from 6 to 8). Alternatively, the method may make use of a hygro-stable pollen paper in step (a) and in this case, the aqueous solution may be an alkaline solution.

Any suitable alkaline solution with any suitable alkaline pH value may be used. For example, the pH of the alkaline solution may be from 9 to 14, such as from 10 to 12. Examples of suitable alkaline solutions include alkaline buffer solutions that provide a suitable pH value. For example, a basic buffer solution of pH 12 may be prepared by dissolving sodium phosphate (0.268 g) dibasic heptahydrate (Na₂HPO₄·7H₂O) in deionised water (100 mL), followed by titrating to pH 12 with KOH.

The pollen paper that has been printed upon by a toner and/or an ink may be immersed in the alkaline solution for any suitable period of time that is able to remove the toner and/or ink and provide a swollen pollen paper. Any suitable period of time that achieves this effect may be used. For example, the period of time may be from 10 seconds to 1 hour, such as from 30 seconds to 10 minutes, such as from 1 minute to 5 minutes, such as about 2 minutes.

The mechanical agitation may be accomplished by any suitable means to assist in the detachment of the toner and/or ink from the surface of the pollen paper. For example, the mechanical agitation may be provided by some form of shaking (e.g. an orbital shaker or the like), sonication (e.g. an ultrasonic cleaning machine), or physical rubbing by hand.

Subsequently, the unprinted hydrated pollen paper can be recycled to its original shrunken state through dehydration (e.g., via ethanol immersion) and, optionally, air-drying. As will be appreciated in a method seeking to recycle pollen paper that has been printed upon, it is only necessary to return the pollen paper to its original size after it has been immersed in the alkaline solution (in which, the pollen paper swells) before conducting the acid-treatment step. This can be achieved solely by immersing the swollen pollen paper (after step (a) of the method above) into a dehydrating solvent for a period of time in order to allow the water to leave the pollen paper and for the paper to return to its original dimensions. Nevertheless, it will be appreciated that after immersion in the dehydrating solvent, the pollen paper may be allowed to dry (e.g. air drying) before the acid treatment step.

Any suitable solvent capable of achieving this dehydration effect may be used. An example of a suitable solvent is an alkyl alcohol. For example, the alkyl alcohol may have from one to ten carbon atoms and from one to six hydroxyl groups. Examples of suitable alcohols include, but are not limited to, methanol, ethanol, n-propanol, i-propanol and combinations thereof. In particular embodiments of the invention, the dehydrating solvent may be ethanol.

Any suitable period of time that allows for the pollen paper to return to its original size after immersion in the dehydrating solvent may be used in the disclosed method. For example, the second period of time in step (b) of the method above may be from 10 seconds to 1 hour, such as from 30 seconds to 10 minutes, such as from 1 minute to 10 minutes, such as about 5 minutes.

As noted above, the pollen paper obtained from the dehydration step may be dried. However, the pollen paper obtained from this step may not be particularly suitable for conventional uses of paper (i.e. retaining its size and flat shape). This is because a dehydrated/dried pollen paper obtained after step (b) of the process will be susceptible to size/shape changes due to changes in relative humidity. For example, if the pollen paper was dried in an ambient environment having a relative humidity of 70%, then the pollen paper will change its shape and/or size if the relative humidity decreases below 70% or increases above it. In order to make the pollen paper stable for use as conventional printed matter (e.g. letters, posters etc.), it has been surprisingly found that this variability in size and conformation can be overcome by subjecting the pollen paper to immersion in an acidic solution for a period of time and then drying the acid-treated paper.

Any suitable acidic solution with any suitable acidic pH value may be used. For example, the pH of the acidic solution may be from 1 to 5, optionally wherein the pH may be from 3 to 4.

Examples of suitable acidic solutions include acidic buffer solutions that provide a suitable pH value. For example, an acidic buffer solution of pH 4 may be prepared by dissolving acetic acid (0.6 g) in DI water (100 mL), followed by titrating to pH 3.99 with KOH.

The dehydrated pollen paper may be immersed in the acidic solution for any suitable period of time that is able to achieve the desired goal of allowing the paper to maintain its desired dimensions, no matter the relative humidity it is exposed to. For example, the third period of time in step (c) of the method above may be from 1 minute to 7 days, such as from 10 minutes to 3 days, such as from 1 hour to 60 hours, such as about 48 hours. After the pollen paper has been dried, it may then be printed upon.

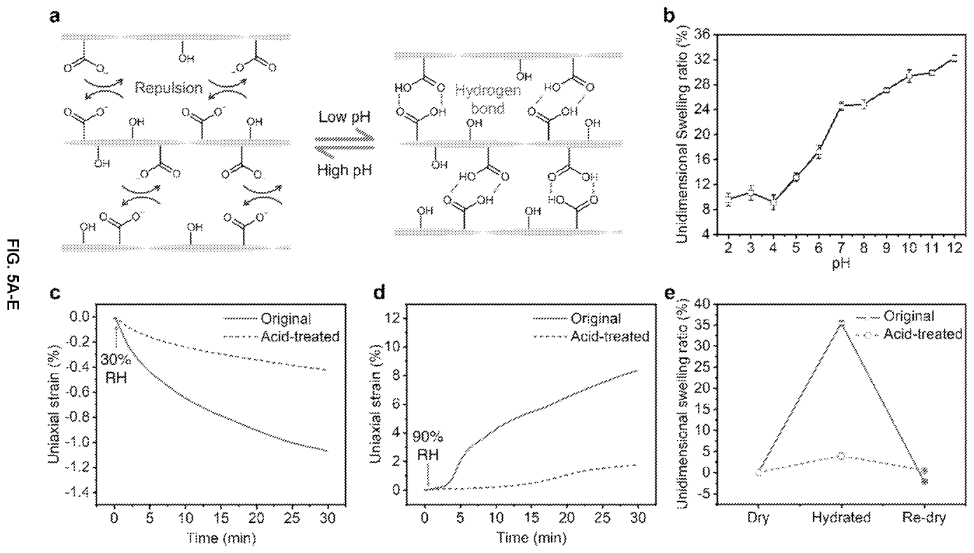

As noted herein, the recycled pollen paper obtained at the end of the process is a hygro-stable pollen paper. The term “hygro-stable” refers to the ability of a paper (e.g. a pollen paper) to resist dimensional changes when subjected to changes in the relative humidity of the ambient environment. A “hygro-stable” paper will essentially retain its original dimensions over a wide relative humidity range (e.g. from 20 to 100%), while a “hygro-instable” paper will suffer significant changes to its dimensions over the same humidity range. In some non-limiting embodiments that may be mentioned herein, a hygro-stable pollen paper may have around 0.4% uniaxial strain, while a hygro-instable pollen paper may have about 1.1% uniaxial strain when subjected to 30% relative humidity (see FIG. 5c). The same pollen papers may display a uniaxial strain of about 1% and 8%, respectively, at 90% relative humidity. In a pollen paper, hygro-stability may also refer to the fact that the paper does not undergo conformational changes due to changes in relative humidity.

Thus, in a further aspect of the invention, there is provided a hygro-stable pollen paper, comprising a plurality of pollen microgels, wherein the hygro-stable pollen paper shows a unidimensional swelling ratio of less than or equal to 5% when immersed in water having a pH of about 7 for 5 minutes.

It will be appreciated that the end product of the process described herein may be hygro-stable pollen paper with these properties. Further, it will be appreciated that the pollen paper that has been printed upon by a toner and/or an ink may be a hygro-stable pollen paper, but this is not essential. As will be appreciated, any pollen paper that has been printed upon (whether hygro-stable or not) may be used in the recycling process disclosed herein. As such, the pollen paper in step (a) of the method above may be a pollen paper that is or is not a hygro-stable pollen paper (e.g. a hygro-stable pollen paper that shows a unidimensional swelling ratio of less than or equal to 5% when immersed in water having a pH of about 7 for 5 minutes; or a hygro-instable pollen paper that shows a unidimensional swelling ratio of greater than or equal to 25% when immersed in water having a pH of about 7 for 5 minutes).

Without wishing to be bound by theory, it is believed that carboxylic acid functional groups present on the surface of the pollen microgels are responsible for whether a pollen paper is in a hygro-stable form or not. For example, if a pollen paper is simply produced using the method outlined herein (i.e. using KOH), then most (if not all) of the carboxylic acid functional groups present on the surface of the pollen microgels will be in the deprotonated form. As such, the deprotonated carboxylic acids will be electrostatically repulsed from one another and this may give rise to the hygro-instability of the pollen paper produced by this route without acid treatment. In contrast, when the pollen paper produced by the method described herein is subsequently treated with acid (either when it is first formed or after recycling), then many (e.g. substantially all) of the carboxylic acid functional groups will become protonated, enabling them to form hydrogen bonds with carboxylic acid functional groups on adjacent pollen microgels, and hence providing the pollen paper with a hygro-stable form.

Thus, in embodiments of the invention, the hygro-stable pollen paper may be one where each of the plurality of pollen microgels has a surface that comprises a plurality of carboxylic acid functional groups, where substantially all of the carboxylic acid functional groups are in the protonated (CO₂H) form.

When used herein, the term “substantially all of the carboxylic acid functional groups are in the protonated (CO₂H) form” means that at least 95%, such as 96%, such as 97%, such as 98%, such as 99%, such as 99.9%, such as 99.99%, such as 99.999%, such as all of the carboxylic acid functional groups are in the protonated (CO₂H) form.

As will be appreciated from the discussion above, it is possible to directly produce a hygro-stable pollen paper without the need for it to undergo recycling first. Thus, in a further aspect of the invention, there is provided a method of forming a hygro-stable pollen paper, the method comprising the steps of:
(ai) providing a pollen paper; and
(aii) subjecting the pollen paper to an acidic solution for a period of time and then drying it to provide a hygro-stable pollen paper.

The pollen paper provided in step (ai) may be any suitable pollen paper that is not itself hygro-stable. For example, it may be made by the process described hereinbefore (e.g. by defatting raw pollen, treating the defatted pollen with a KOH solution to provide pollen microgels (also described herein as pollen microparticles), which are then cast into a mold to provide a pollen paper that is not hygro-stable).

The process to make the pollen paper first involves defatting the pollen, which can then be mixed with a solution (e.g. 10% w/w) of KOH at an elevated temperature (e.g. about 80° C.) for a suitable period of time (e.g. about 5 hours) to produce soft pollen microgels. These soft pollen microgels can then be collected and washed, cast into a mold and then left to dry to produce a pollen paper comprising the soft pollen microgels, which has a microscopically rough surface topography, owing to the intrinsic nano- and microstructures of the self-assembled pollen grains. As will be appreciated, the dimensions of the paper are not only limited by the casting mold used but also by the area where the pollen microgels spread and cover. It will be appreciated that any suitable pollen may be used to manufacture a pollen paper (e.g. sunflower pollen, Camellia pollen, Lotus pollen, or Poppy pollen).

Any suitable acidic solution with any suitable acidic pH value may be used. For example, the pH of the acidic solution may be from 1 to 5, optionally wherein the pH may be from 3 to 4. Examples of suitable acidic solutions include acidic buffer solutions that provide a suitable pH value. For example, an acidic buffer solution of pH 4 may be prepared by dissolving acetic acid (0.6 g) in DI water (100 mL), followed by titrating to pH 3.99 with KOH.

The provided pollen paper may be immersed in the acidic solution for any suitable period of time that is able to achieve the desired goal of allowing the paper to maintain its desired dimensions, no matter the relative humidity it is exposed to. For example, the period of time in step (aii) of the method above may be from 1 minute to 7 days, such as from 10 minutes to 3 days, such as from 1 hour to 60 hours, such as about 48 hours. After the pollen paper has been dried, it may then be printed upon.

As will be appreciated, the resulting hygro-stable pollen paper may provide the same properties as described hereinbefore for such materials and so the properties of the hygro-stable pollen paper will not be discussed again for the sake of brevity.

Further aspects and embodiments of the invention will now be discussed by reference to the following non-limiting examples.

### EXAMPLES

Materials

Sunflower bee pollens (Helianthus annuus L.) were purchased from Shaanxi GTL Biotech Co., Ltd (Xi'an Shaanxi, China). Acetone, diethyl ether, acetic acid, sodium phosphate dibasic heptahydrate (Na₂HPO₄·7H₂O), hydrogen chloride (HCl), and potassium hydroxide (KOH) were purchased from Sigma-Aldrich Pte Ltd (Singapore). Nylon meshes were purchased from ELKO Filtering Co. LLC (United States of America).

Analytical Techniques

Optical Photographs and Microphotographs

Optical photographs and videos were taken in 4k resolution through an iPhone 12 (Apple Inc.). Optical microphotographs were taken using a stereomicroscope with a parallel light (Nikon, Tokyo, Japan).

Scanning Electron Microscopy (SEM)

SEM images were obtained by a JSM-7600F Schottky field-emission scanning electron microscope (JEOL, Tokyo, Japan) at an accelerating voltage of 5.00 kV.

Unidimensional Swelling Rate Calculation

A sheet of pollen paper was cut into small pieces of 2 mm×3 mm for this experiment. Microphotographs of the small pollen papers at different treatments were taken, and the lengths of their short sides were measured using software ImageJ (National Institutes of Health, Bethesda, MD, USA). The unidimensional swelling rate is given by

R=(L₁−L₀)/L₀

Where R is the unidimensional swelling rate; L₀ is the initial length of the pollen paper at originally dry state before treatment; and L₁ is the length of the pollen paper subjected to treatments for 5 min.

### Example 1. Preparation of Pollen Paper

The pollen-based paper was made adapting from the inventors' previous work (Z. Zhao et al., Proc. Natl. Acad. Sci. U.S.A. 2020, 117, 8711). Defatted pollen grains was transformed into soft materials via pollen shell extraction and KOH incubation. After incubation, the microgel particles were diluted with DI water until the pH was 7, and cast into a desired mold for air-drying to obtain pollen paper.

Raw sunflower bee pollen granules (100 g) were mixed with DI water (400 mL) under stirring for 1 h. Then, the pollen suspension was passed through a nylon mesh with 200 μm diameter pores to remove any contaminating particulate matter. The filtered pollen sample was successively refluxed in acetone (200 mL) and diethyl ether (200 mL) under stirring for 12 h. All the organic solvents were removed by vacuum-filtering the defatted pollen samples. Afterward, the resulting defatted pollen grains (˜20 g) were subjected to the alkaline solution digestion step, where they were mixed with KOH solution (40 mL, 10 wt %) under stirring at 80° C. for 5 h. Subsequently, the hydrolyzed pollen samples were washed with fresh 10% KOH solution using a nylon mesh with 20 μm diameter pores until the filtrate became clear, and then diluted with DI water until the pH was 7. Finally, the treated pollen grains were cast into a petri dish for air-drying under ambient conditions to obtain pollen paper.

Results and Discussion

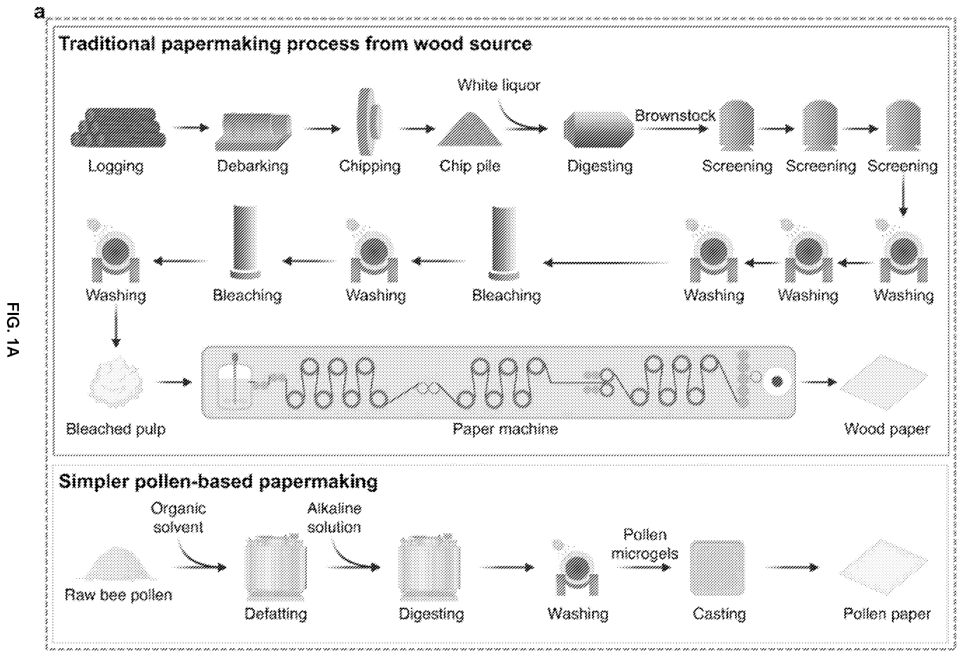

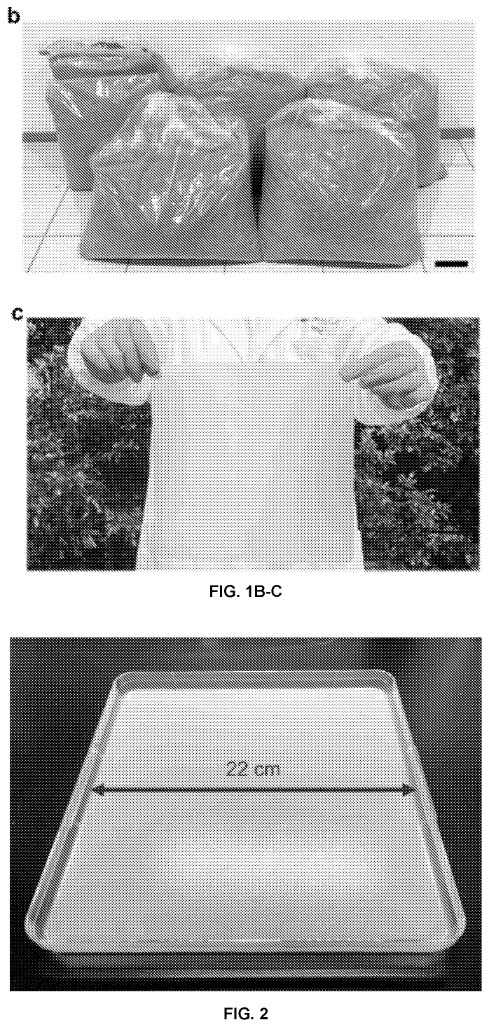

To manufacture conventional wood-derived papers, trees in the forest initially go through mechanical logging, debarking, and chipping to become small-sized woodchips, then are chemically digested into brown cellulose-based pulp. After that, stepwise screening, bleaching, and washing are applied to make the pulp whitened for fabricating final paper products suitable for printing (E. Sjöström & R. Alén, Analytical methods in wood chemistry, pulping, and papermaking, Springer Science & Business Media, Berlin/Heidelberg, Germany 1998), as shown in FIG. 1a, upper panel. In contrast to the complicated, energy-intensive, and environmentally hazardous wood-based papermaking process, our pollen papers are derived from natural micro-sized pollen grains via chemical treatments (without any mechanical processing) that resemble the traditional soapmaking process (E. Letcavage, Basic soap making: All the skills and tools you need to get started, Stackpole Books, Mechanicsburg, PA, USA 2009) (FIG. 1a, lower panel).

In this study, pollen grains from sunflower plants (Helianthus annuus) were used due to their outstanding gelation property based on the inventors' previous works (T. F. Fan et al., Nat. Commun. 2020, 11, 1449). Further, due to the inherent microscale of pollen, the raw pollen grains can be instantly transformed into micro-building blocks that can directly self-assemble into a paper-like material, adapting from our previous works (T. F. Fan et al., Nat. Commun. 2020, 11, 1449; and E. Sjöström & R. Alén, Analytical methods in wood chemistry, pulping, and papermaking, Springer Science & Business Media, Berlin/Heidelberg, Germany 1998). The pollen-based papermaking was started from commercial raw bee pollen, an abundant and inexpensive bee farm by-product directly gathered and packed by worker honeybees (FIG. 1b, M. Thakur & V. Nanda, Trends Food Sci. Technol. 2020, 98, 82). As genetic material carriers in plant reproduction, pollen is generated in large abundance and renewably, the latter of which is important for environmental sustainability, unlike logging in conventional wood-based papermaking (S. E. Hoover, L. P. Ovinge, J. Econ. Entomol. 2018, 111, 1509; and R. W. Thorp, The collection of pollen by bees. In: Dafni A., Hesse M., Pacini E. (eds) Pollen and Pollination. Springer, Vienna 2000).

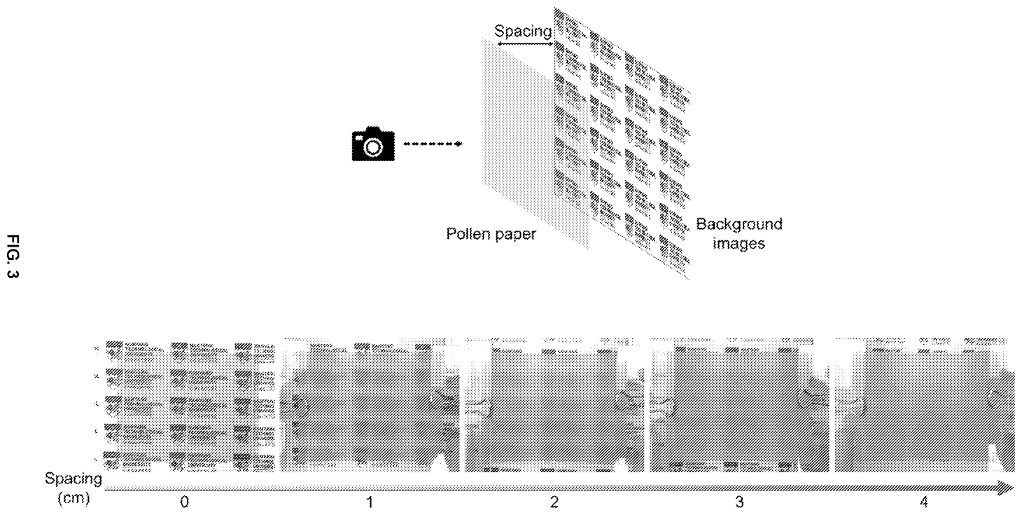

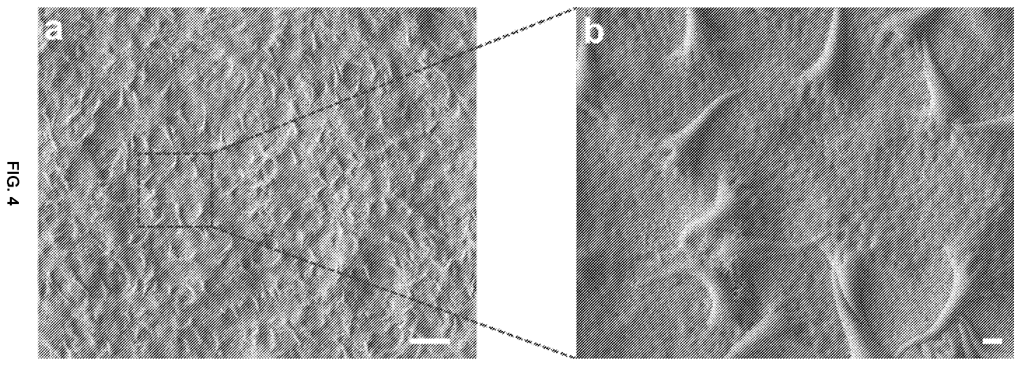

After a simple defatting step, the resultant defatted pollen was subjected to a critical process of alkaline solution digestion step similar to the digesting step in wood-based papermaking, where the hard pollen was continuously hydrolyzed 5 h to form soft microgels. We used DI water to dilute the pollen microgels to pH 7, and then easily cast them into a mold for air-drying (FIG. 2). When the water evaporated, a piece of pollen paper with a 22×22 cm size and a thickness of approximately 30 μm was produced (FIG. 1c). The dimensions of the fabricated pollen paper are highly customizable and scalable by employing different casting molds. Unlike opaque wood-derived paper, pollen paper is light-permeable. However, it showed a high level of translucency that could haze the background in a tunable manner depending on the spacing (FIG. 3). The natural optical characteristic is endowed by the intrinsic nano- and micro-structures of the self-assembled pollen grains with spiky morphology (FIG. 4, Y. Hwang et al., Adv. Mater. 2021, 33, 2100566), which is sufficient for printing.

Therefore, an eco-friendly alternative to the wood-derived printing paper is shown in this work, which could be instantly produced from renewable pollen grains via a fast and straightforward chemical method without heavy mechanical processing.

### Example 2. Energy Consumption

In the pollen paper production process in Example 1, the alkaline solution digestion step is the only step that requires heating, a dominant energy-consuming part in manufacturing. To demonstrate the energy-saving efficiency of pollen-based papermaking, the analogous digesting processes in wood- and pollen-based papermaking was compared in detail. The digestion process involves the input of raw biomass, alkaline solvents, and energy for heating (Table 1).

TABLE 1
Comparison of the critical digesting processes
in wood-based and pollen-based papermaking.

| | Wood paper | Pollen paper |
|---|---|---|
| Key digesting step | Kraft cooking | Alkaline solution |
| | (D. Mboowa, Biomass Conv. | digesting |
| | Bioref. 2021) | |
| Raw biomass | Woodchips | Defatted pollen |
| Chemical solvent (ingredients | White liquor (8% NaOH, 3% Na₂S, | KOH solution (10% |
| composition, wt %) | 89% water, C. J. Biermann, 22 - | KOH, 90% water) |
| | Papermaking Chemistry, Academic | |
| | Press, San Diego 1996) | |
| Ratio of solvent to raw | 4:1 | 2:1 |
| materials [V/W] | (H. Sixta, A. Potthast & A. W. | |
| | Krotschek, Chemical Pulping | |
| | Processe: Sections 4.1-4.2.5, | |
| | WILEY-VCH Verlag Gmbh &Co. | |
| | KGaA, Weinheim, Germany 2006) | |
| Production yield [%] | 50 | 5 |

Calculations of Energy Consumption

Relevant parameters and equations needed for the energy calculation are listed in Table 2.

$${Q}_{react} = \frac{{Q}_{heart} + {Q}_{loss}}{{η}_{heat}} = \frac{{C}_{p} \cdot {m}_{mix} \cdot ( {T}_{r} - {T}_{0} ) + A \cdot \frac{{K}_{a}}{s} \cdot ( {T}_{r} - {T}_{0} ) \cdot t}{{η}_{heat}} \qquad ( 1 )$$

The calculations of energy consumption for digesting steps in wood and pollen-based papermaking were based on Equation (1), which includes the energy for raising the temperature (Qₕₑₐₜ) and the heat loss during the reaction (Qₗₒₛₛ, F. Piccinno et al., J. Clean. Prod. 2016, 135, 1085). Here, ηₕₑₐₜ is the assumed efficiency of the heating device, Cₚ is the specific heat capacity of the mixture, mₘᵢₓ is the mass of the mixture, Tᵣ is the digesting temperature, T₀ is the ambient temperature of 25° C., A is the surface area of the reactor with an assumed value of 27.381, Kₐ is the thermal conductivity of the insulation material with an assumed value of 0.042 W m⁻¹ K⁻¹, s is the thickness of the insulation with an assumed value of 0.075 m, t is the digesting time, and ηₕₑₐₜ is the efficiency of the heating device with an assumed value of 79%. Cₚ is estimated as the average mass fraction of the pure components, i.e., raw materials and corresponding digesting components.

TABLE 2
Parameters required for calculating the
heat energy to prepare 1000 kg of paper.

| | Wood | Pollen |
|---|---|---|
| Raw biomass needed [kg] | 2000 | 20000 |
| Digesting solvent [m³] | 8 | 32 |
| Specific heat capacity of the raw biomass | 1760 | 1100^{a)} |
| [J · kg⁻¹ · K⁻¹] | 3842.5 | 2719.1 |
| Specific heat capacity of the mixture | | |
| Digesting temperature [° C.] | 180 | 80 |
| Digesting time [h] | 3 | 5 |
| Calculated energy consumption [GJ] | 6.32 | 6.27 |

^{a)}This value is assumed as the specific heat capacity of solid lignin (M. Zanotti et al., Green Chem. 2016, 18, 5059).

Results and Discussion

It was found that the two chemical processes consume a similar amount of heating energy, 6.32 GJ for wood and 6.27 GJ for pollen when preparing 1000 kg of paper. However, wood-based papermaking consumes more energy for mechanical processes like logging, debarking, and chipping, which are more energy-intensive because of their low energy conversion efficiency into mechanical work (P. Bajpai, Chapter 3—Pulp and Paper Production Processes and Energy Overview, Elsevier, Amsterdam 2016). Therefore, benefiting from a one-pot chemical digesting process, the innovative pollen-based papermaking is more straightforward, fast, sustainable, requiring less total energy.

### Example 3. Simple Acid Treatment to Improve Hygro-Stability of Pollen Paper

As demonstrated in the inventors' previous work (Z. Zhao et al., Proc. Natl. Acad. Sci. U.S.A. 2020, 117, 8711; and Z. Zhao et al., Proc. Natl. Acad. Sci. U.S.A. 2021, 118, e2113715118), varying RH can alter the configurational, morphological, and mechanical characteristics of the original pollen paper. However, insensitivity to moisture is considered essential for practical use of printing substrates. Therefore, given the pH-dependent morphological response of the pollen microgel particles (T. F. Fan et al., Nat. Commun. 2020, 11, 1449), it was hypothesized that acid treatment could hygro-stabilize the as-assembled pollen paper, where carboxylic acid functional groups should become protonated to form more hydrogen bonds with one another (FIG. 5a).

Acid Treatment for Pollen Paper

Acidic solution buffer pH 4 was prepared by dissolving acetic acid (0.6 g) in DI water (100 mL), followed by titrating to pH 3.99 with KOH. The pollen paper prepared in Example 1 was immersed in the solution for 48 h. Then, the acid-treated pollen paper was taken out and put through air-drying to dehydrate for further testing, and digital printing in Example 4.

Uniaxial Strain Test

A thin ribbon of pollen paper (25 mm×5 mm×0.03 mm) was mounted in a film tension clamp on the DMA Q800 equipped with the DMA-RH Accessory to control RH. Given the surrounding humid environment (˜60% RH), the pollen ribbons' uniaxial strains as the RH changed from 60% to set values (30% or 90%) were measured. Then, the following method program was employed.
1) Stress=0 MPa (removes all residual force)
2) Relative humidity x % (sets RH control, x=30% or 90%)
3) Isothermal for 60 min (allows time for humidity chamber to reach the set RH level)
4) Measure Length
5) Close the chamber
6) Isothermal for 60 min (allows time for the sample to equilibrate under set RH level)

The uniaxial strain was obtained from the strain recorded in the datasheet. The test was performed three times to get the average value.

Results and Discussion

To adapt pollen paper to applications in varying relative humidity (RH), we significantly improved the hygro-stability of the pollen paper through simple acid treatment, thereby protecting the printed information from moisture damage.

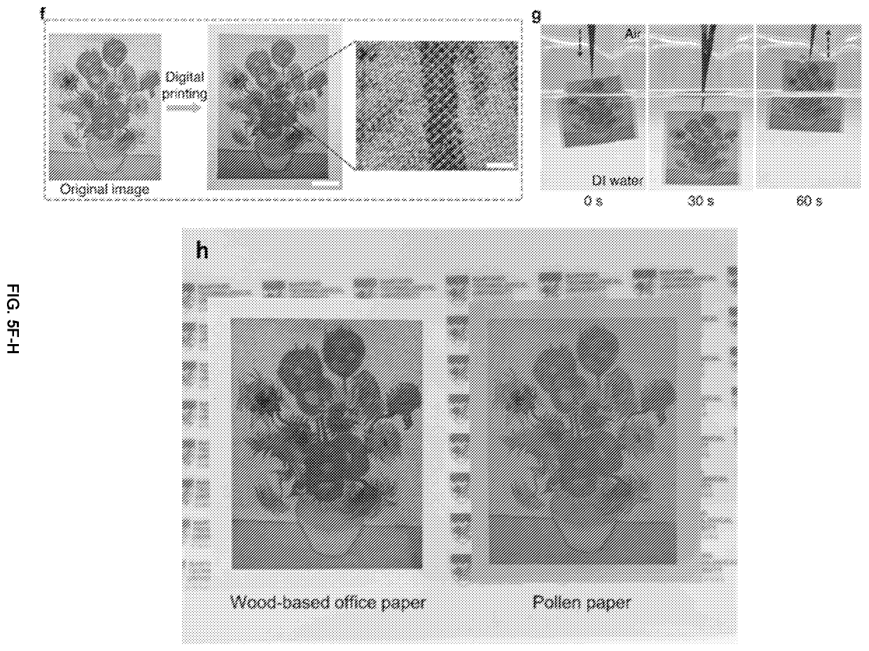

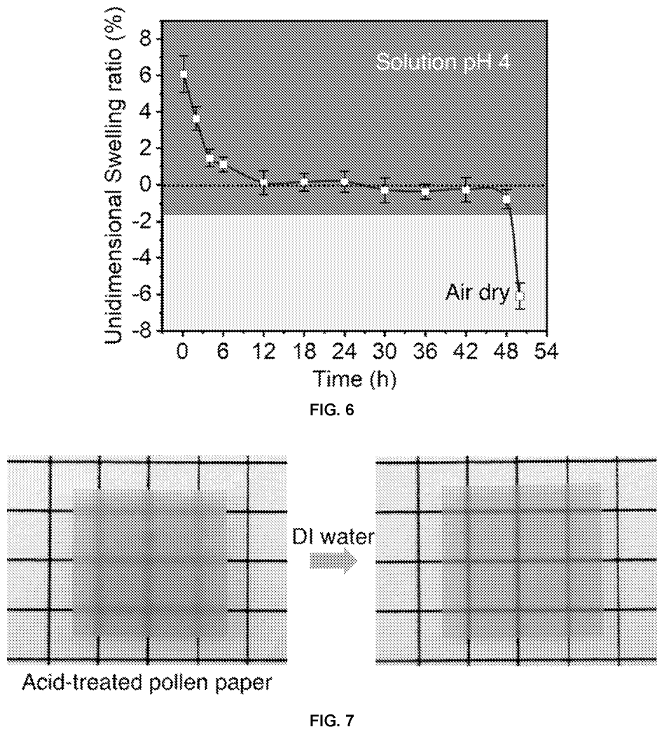

When immersed in solutions of different pH values (from 2 to 12, prepared by dissolving corresponding amounts of HCl or NaOH into DI water, where a pH meter (Accumet™ AB15 Basic, Thermo Fisher Scientific, Waltham, Massachusetts, U.S.) was used to monitor the pH) for 10 min, the unidimensional swelling ratio of the pollen paper clearly decreased with the decreasing pH value (FIG. 5b). It was found that the pollen paper had the lowest swelling ratio at pH 4. In addition, the initially swollen pollen paper underwent gradual de-swelling over time and reached equilibrium after 48 h, with a final size slightly smaller than the dry, untreated pollen paper (FIG. 6). Then, the pollen paper immersed in pH 4 solution for 48 h was air-dried and stored in ambient conditions for further characterization.

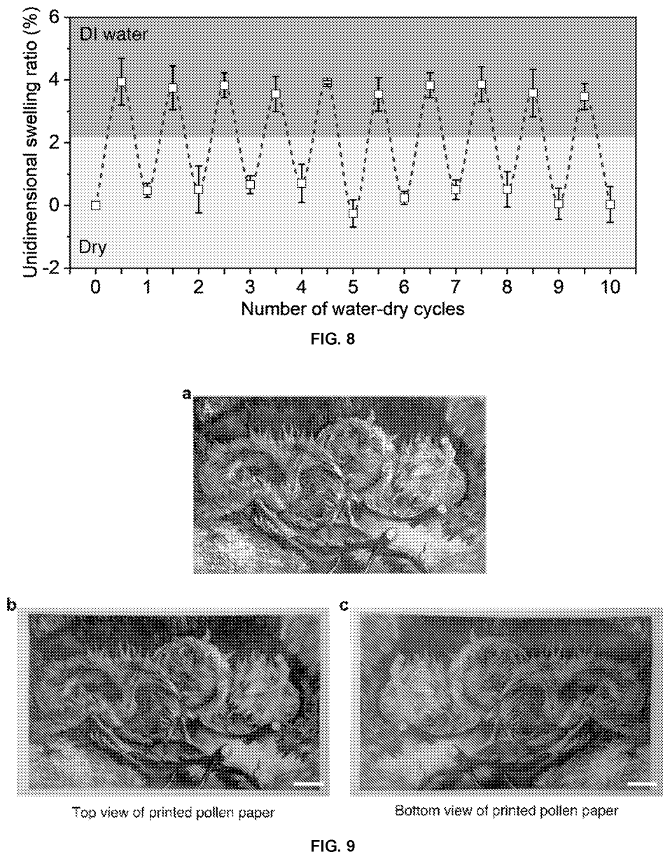

We investigated the hygro-stability of the acid-treated pollen paper's dimensions during exposure to different values of RH, as shown in FIG. 5c-d. Compared with the original untreated pollen paper, the acid-treated pollen paper demonstrated much less shrinkage or swelling when transferred from 60% RH (room RH) to 30% RH or 90% RH, respectively. Additionally, when exposed to DI water for 5 min, the hydrated acid-treated pollen paper exhibited a unidimensional swelling ratio of about 4% (FIG. 7), which is only about 11% of the value of hydrated untreated pollen paper (FIG. 5e). Multiple hydration-dehydration cycles were conducted on the acid-treated pollen paper to test the reversibility and durability of its hygro-stability. As shown in FIG. 8, the sample retained its small swelling ratio during nine cycles and shrank back to its initial size after each dehydration.

Thus, the experiments showed that the acid-treated pollen paper exhibits unique characteristics of basic pH-induced swelling.

### Example 4. Printability of Hygro-Stable Pollen Paper

To demonstrate the printability of the acid-treated hygro-stable pollen paper prepared in Example 3, the image of a world-famous painting of sunflowers by Vincent van Gogh was selected as the color source to be printed (FIG. 5f, left).

Laser Printing of Pollen Paper

For color printing, HP Color LaserJet Managed MFP E77830dn (HP Inc., Palo Alto, California, United States) was used with HP cyan, yellow, and magenta Managed LaserJet Toners (HP Inc., Palo Alto, California, United States). For monochrome printing, HP LaserJet Pro MFP M428fdn (HP Inc., Palo Alto, California, United States) was used with HP 58A Black Original LaserJet Toner (HP Inc., Palo Alto, California, United States). Before printing, fabricated pollen paper was stuck on an A4 paper to go through the laser printer tray. As a control, the same colorful image was printed on a common office A4 printer paper (PaperOne™ Copier paper, APRIL International Enterprise Pte. Ltd., Singapore).

Results and Discussion

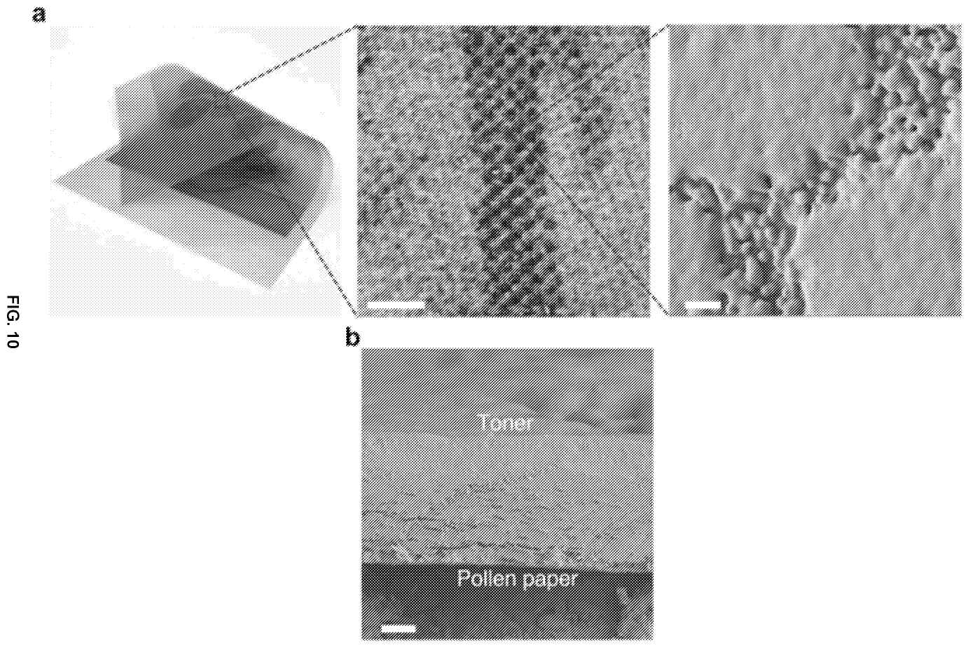

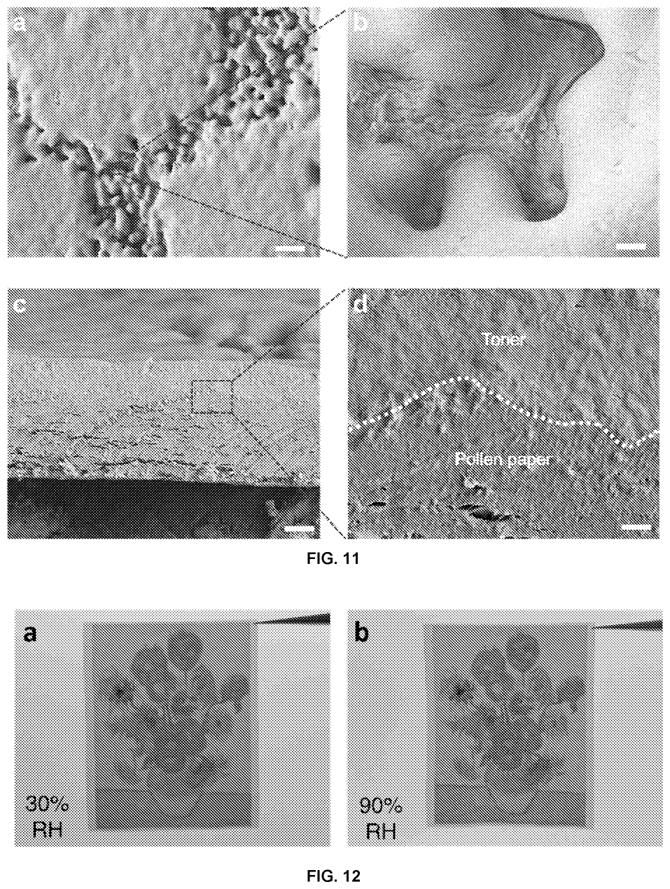

Owing to its good mechanical strength and flexibility, the acid-treated pollen paper could pass through the laser printer smoothly without any tears or damage. As a result, the printed image of sunflower painting on the pollen paper exhibited high resolution, high degree in clarity and color fidelity (FIG. 5f, middle), comparable to the print on a wood-based office paper (FIG. 5h). Due to the translucency of the pollen paper, we could also see the printed image in mirror form from the backside (FIG. 9). The printed pollen paper remained flexible and could be easily rolled or folded into different shapes (FIG. 10a, left). Using an optical microscope, we found that the color toner covered the printed areas completely without any apparent gaps or flaws (FIG. 10a, middle). SEM images showed that the toner printed on the pollen paper fused and formed a coating layer with discrete pits, whose micromorphology depended on the print setup (FIG. 10a, right, and 11a-b, N. Attard-Montalto et al., Analyst 2014, 139, 4641). Due to the unique intrinsic microstructure of the pollen paper with large roughness (Z. Zhao et al., Proc. Natl. Acad. Sci. U.S.A. 2020, 117, 8711), the fused toner was conformally deposited along the contour of its surface, ensuring a tight bond between the toner and pollen paper with superior abrasion resistance (FIGS. 10b and 11c-d).

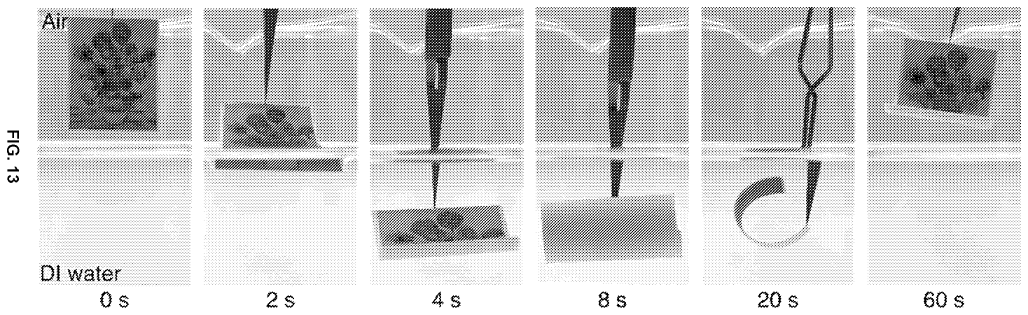

In light of its enhanced hygro-stability, the acid-treated pollen paper printed with “Sunflowers” could preserve its form and the integrity of the printed image for at least 24 h regardless of the low (30%) or high (90%) RH (FIG. 12). Moreover, we found that 1 min of contact with DI water would not soften or damage the mechanical structure of the printed sample (FIG. 5g), performing even better than wood-based office printer paper in its resistance to the water-induced weakening of mechanical strength (FIG. 13). Taken together, these results reveal that simple acid treatment can remarkably improve the hygro-stability of the pollen paper, making it a potentially sustainable substitute for wood-based printer paper in a variety of printing and publishing environments.

### Example 5. pH-Response of Acid-Treated Pollen Paper

The acid-treated pollen paper has many potential advantages over traditional wood-based paper even for single use. In addition to that, there are simple steps one can take to unprint the pollen paper on demand by removing all printed toner content and then recycle it for new printing. For this purpose, we further harnessed the pH-response of the pollen paper and hypothesized that a strong interaction occurs between the paper and the printed toner during immersion in basic solution that can cause extensive swelling of untreated pollen paper (FIG. 5b). A blank acid-treated pollen paper (prepared in Example 3) without printed information was immersed in a solution of pH 12 to evaluate the base-induced effect on its dimensions.

Results and Discussion

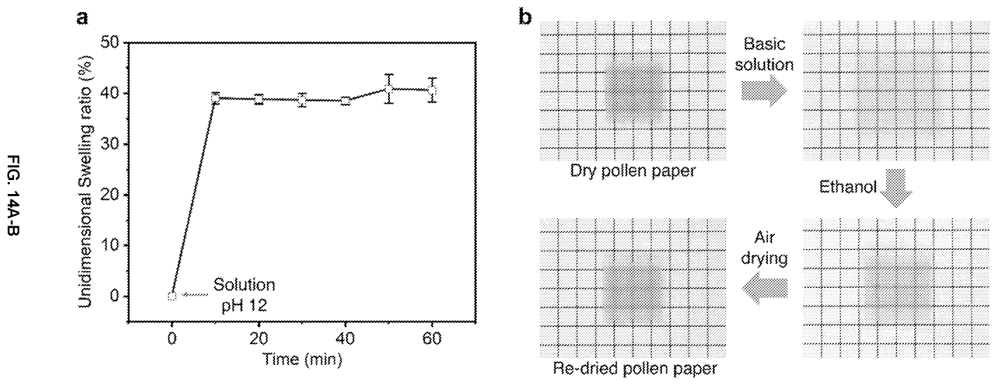

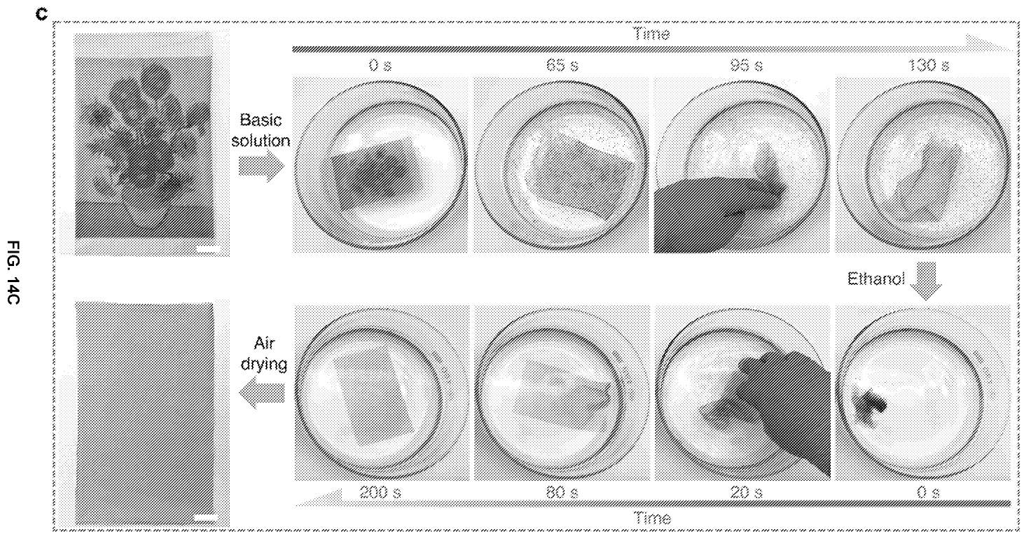

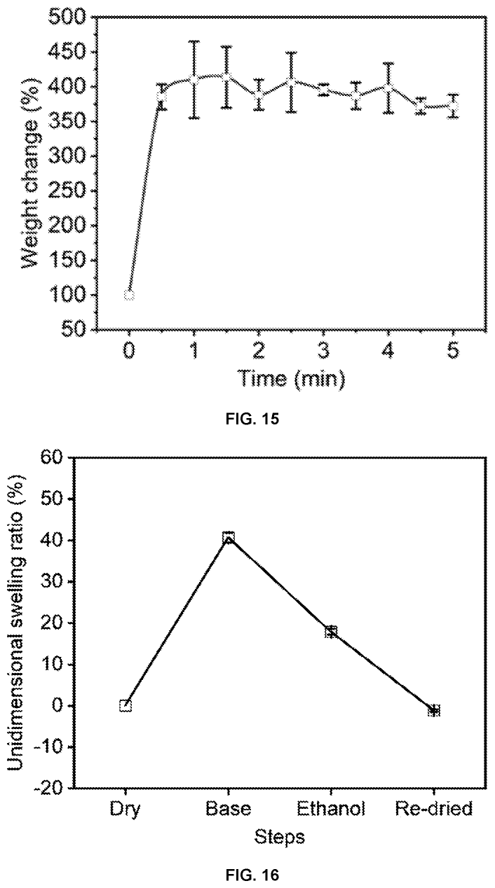

As shown in FIG. 14a, in contrast with the slight swelling (4%) resulting from neutral DI water immersion, the acid-treated pollen paper underwent a rapid swelling of approximately 40% when immersed in the basic pH solution, maintaining its swollen state for 1 h. The weight change of the pollen paper during basic solution absorption was measured, with the result indicating that the pollen paper could quickly reach a plateau in its swelling response within 1 min (FIG. 15).

### Example 6. Responsive Behaviour of Pollen Paper to Water-Ethanol-Drying Treatment

Herein, a multistep treatment of ethanol-drying was designed to facilitate the in-situ recycling of pollen paper from its swollen state, where ethanol, an eco-friendly and easily accessible solvent, was used to achieve fast dehydration.

In Situ Recycling of the Printed Pollen Paper

First, a toner erasing solution, namely a basic solution buffer (pH=12), was prepared by dissolving sodium phosphate dibasic heptahydrate (Na₂HPO₄·7H₂O, 0.268 g) in DI water (100 mL), followed by titration to pH 12 with KOH. Next, the printed pollen paper was immersed in the solution under slight agitation for 2 min to remove the toner fragments from the pollen paper. Then, the hydrated pollen paper was transferred from water to ethanol, a water-miscible organic solvent, to dehydrate and shrink for 5 min. Finally, it was dried in ambient air to complete the paper recycling.

Results and Discussion

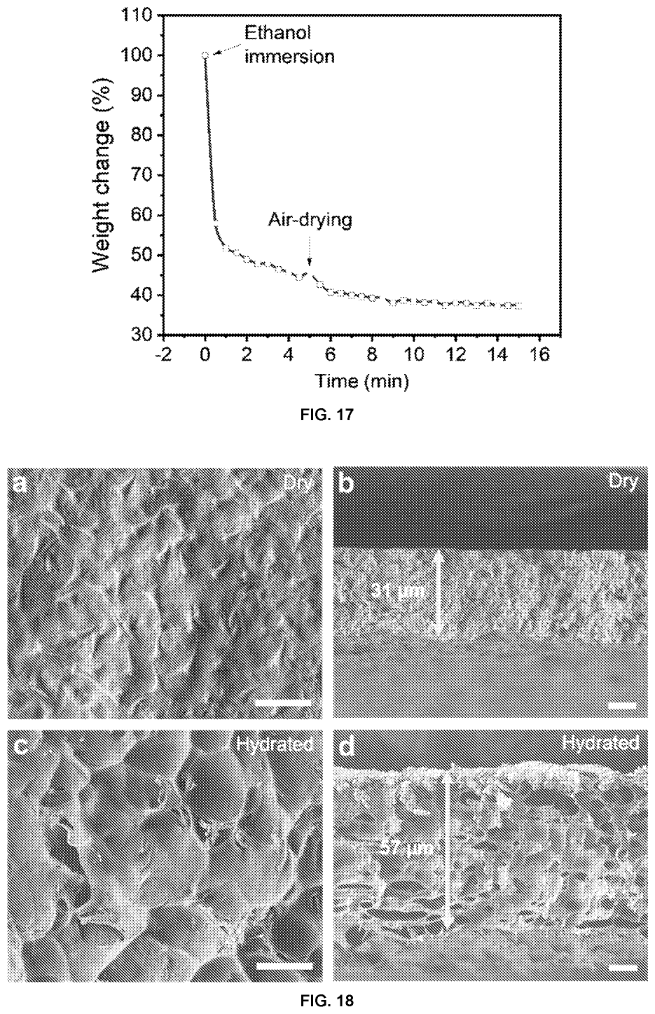

The dehydrating behavior of the immersed pollen paper in response to the ethanol-drying treatment was studied. FIG. 14b shows a square paper sample, where the background grid pattern makes the size change evident, subjected to different treatments. First, in this process, the acid-treated pollen paper immersed in basic solution swelled to almost twice its original surface area. Then, the hydrated pollen paper was transferred to ethanol to dehydrate and de-swell, followed by an air-drying step, which took around 10 min to restore the pollen paper to its initial size and weight (FIG. 16-17), demonstrating the reversibility of its dimensional changes. The SEM images showed that the dry pollen paper exhibited a typical fallen spiky surface microstructure (FIG. 18a), whereas the hydrated pollen paper exhibited numerous irregular crater-like morphologies (FIG. 18c). Additionally, the dry pollen paper exhibited a compact lamellar cross-section (FIG. 18b), whereas the hydrated pollen paper exhibited a considerably higher cross-sectional thickness, owing to the numerous porous microstructures within its body (FIG. 18d).

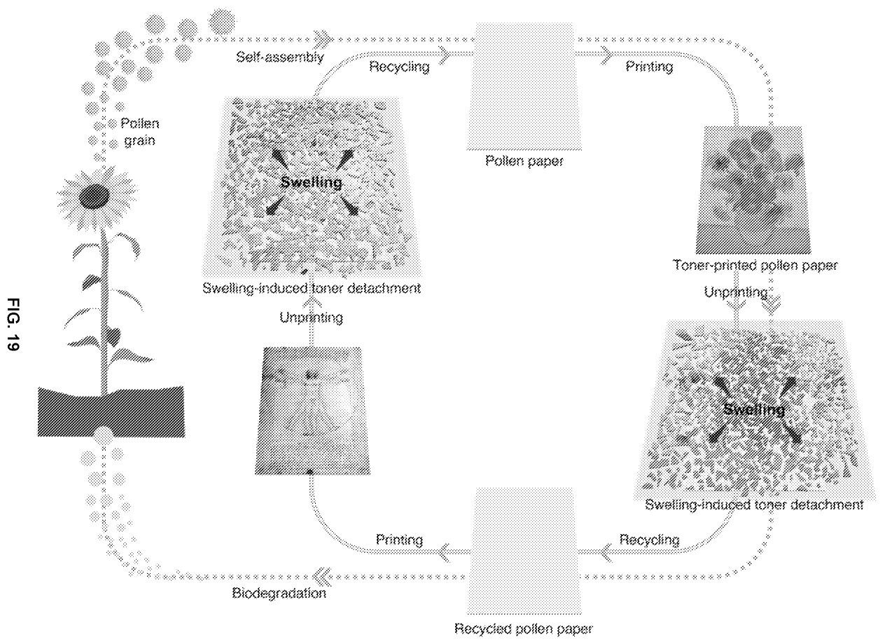

Taking the results in Examples 5 and 6 together, we found that pollen paper possessed a unique characteristic of water-induced dramatic swelling in size and change in surface microtopography, which would disintegrate the attached toner layer into small pieces. With mild oscillation or ultrasonication assistance, these toner fragments could be easily removed from the printed pollen paper, not involving any high-energy physical methods. Subsequently, the “unprinted” hydrated pollen paper could be recycled to its original shrunken state through two-step dehydration of ethanol immersion and air-drying process. The whole process is shown in FIG. 19.

### Example 7. Recycling of Laser-Printed Acid-Treated Pollen Paper

Based on the findings in the above examples, a complete process to unprint and recycle the pollen paper was set up, as shown in FIG. 14c.

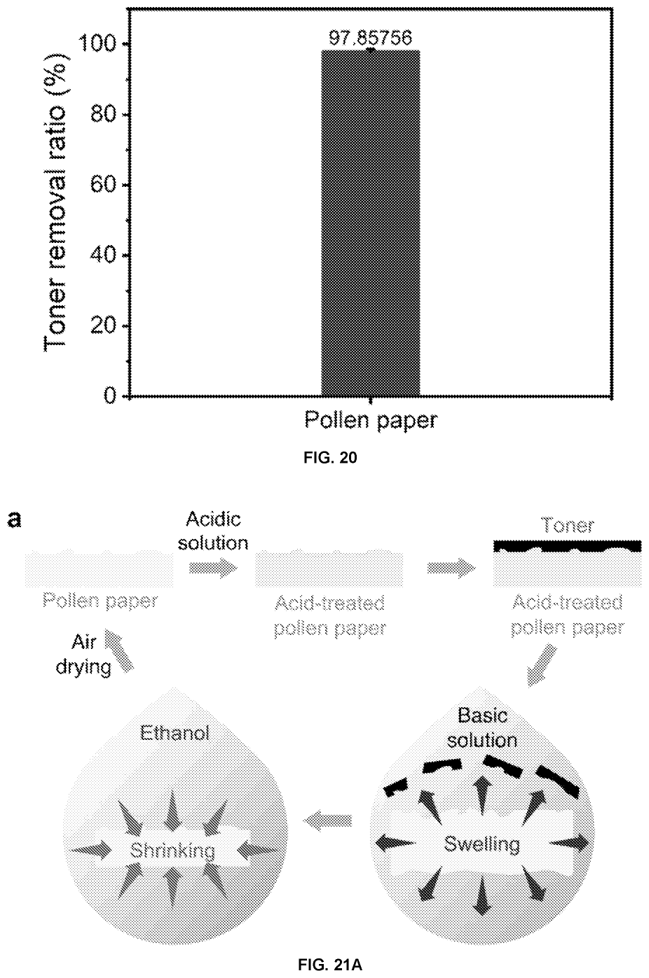

When immersed in a basic solution, the pollen paper underwent rapid swelling. Subsequently, small fragments of the printed toner gradually separated from the pollen paper under mild mechanical agitation (FIG. 14c, upper panel). After a short period of 2 min, about 98% of the printed toner was removed from the pollen paper and dispersed in solution (FIG. 20). Next, a bath of ethanol was prepared to dehydrate the unprinted pollen paper for 5 min, which was then taken out and air-dried (FIG. 14c, lower panel). In summary, a basic solution can be used to trigger toner removal, and the pollen paper can easily be processed to return to its original shape and dimensions after dehydration by recourse to ethanol treatment and air-drying.

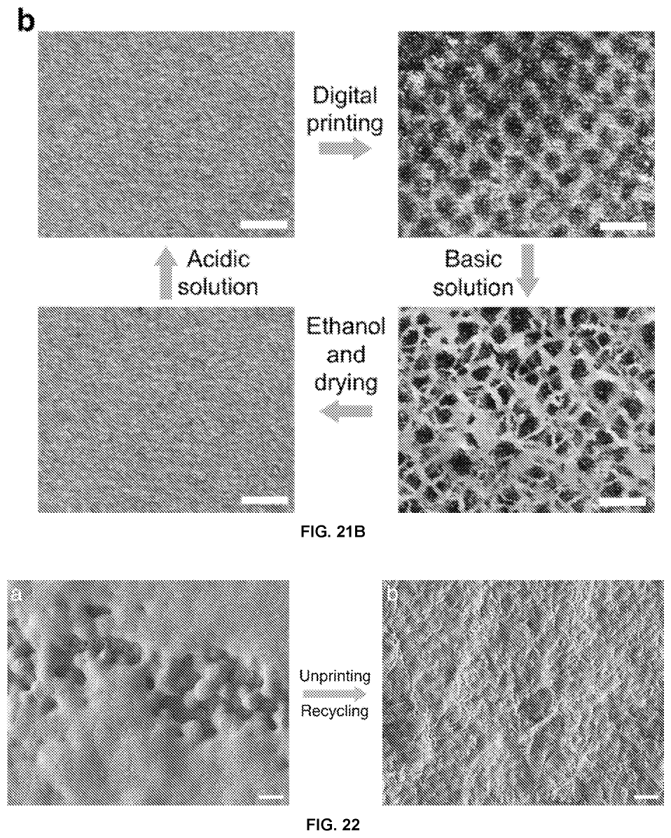

FIG. 21a schematically depicts the printing and unprinting of the pollen paper to further elucidate the process of separation between the pollen paper and toner. Before immersion in the basic solution, the printed toner layer conformally bonded with the acid-treated pollen paper surface contours. During swelling, the toner layer mechanically disintegrated, thereby fully debonding from the paper surface and leading to complete toner removal. After ethanol immersion and air-drying, the acid treatment was readministered to the recycled pollen paper to prepare it for new printing. Under a microscope, we observed the forced disintegration and looseness of the colour toner relative to the pollen paper under the stimulation of basic solution (FIG. 21b). The recycled pollen paper resembled the original, without any toner residues and microstructural damage, as further verified by the SEM images (FIG. 22).

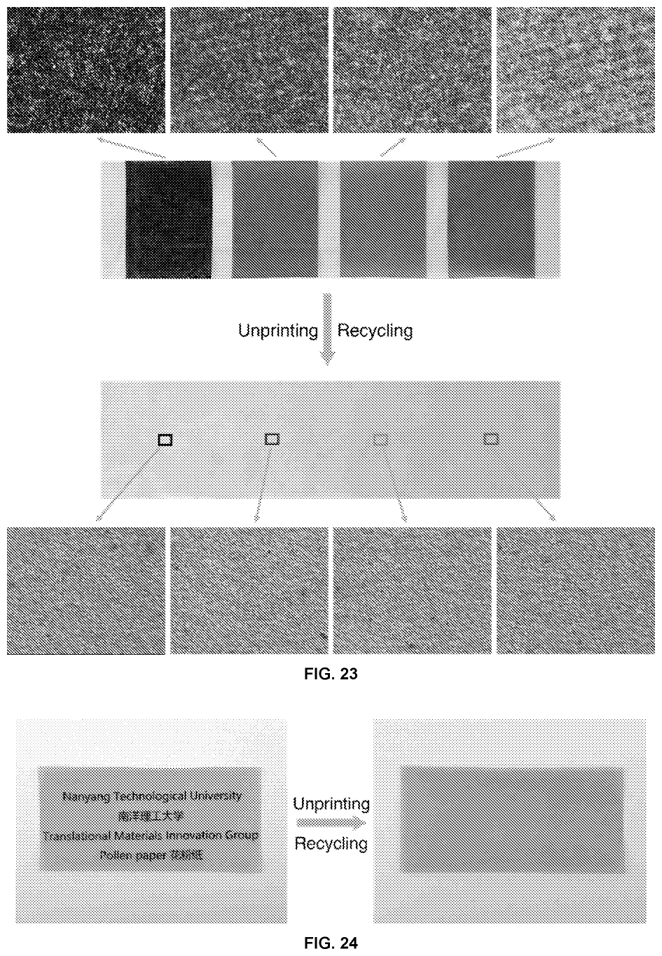

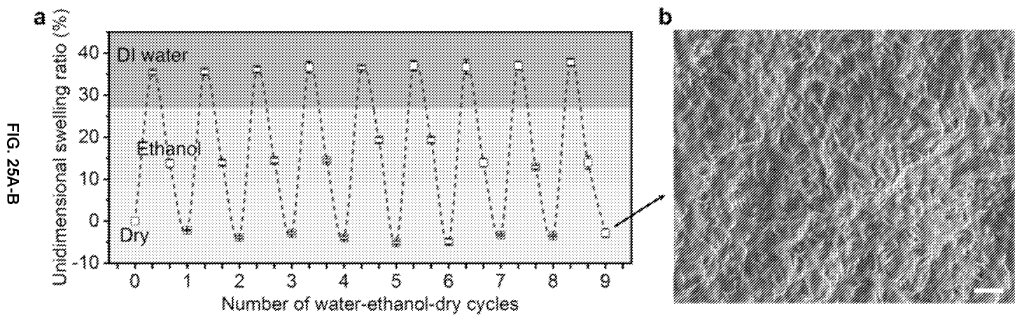

Because toner removal is a mechanical process, unprinting should be universal and effective for different toner types, irrespective of their color or composition. To confirm this assumption, we printed four zones with different toner colors (black, red, green, and blue) on a single pollen paper sheet and unprinted the paper using the method described above. The toners in the four zones were essentially completely removed, with no significant differences between them (FIG. 23). In another experiment, we printed text using a laser printer and a monochrome (black) toner and obtained the same result (FIG. 24). Thus, our results indicate that laser-printed pollen paper can be unprinted and reused for further printing through simple processing steps, regardless of the toner type.

### Example 8. Re-Usability of the Recycled Pollen Paper

Re-usability of the recycled pollen paper is essential for its practical applications in different scenarios to enable which stable reversibility of the swelling behavior of the pollen paper is indispensable.

Results and Discussion

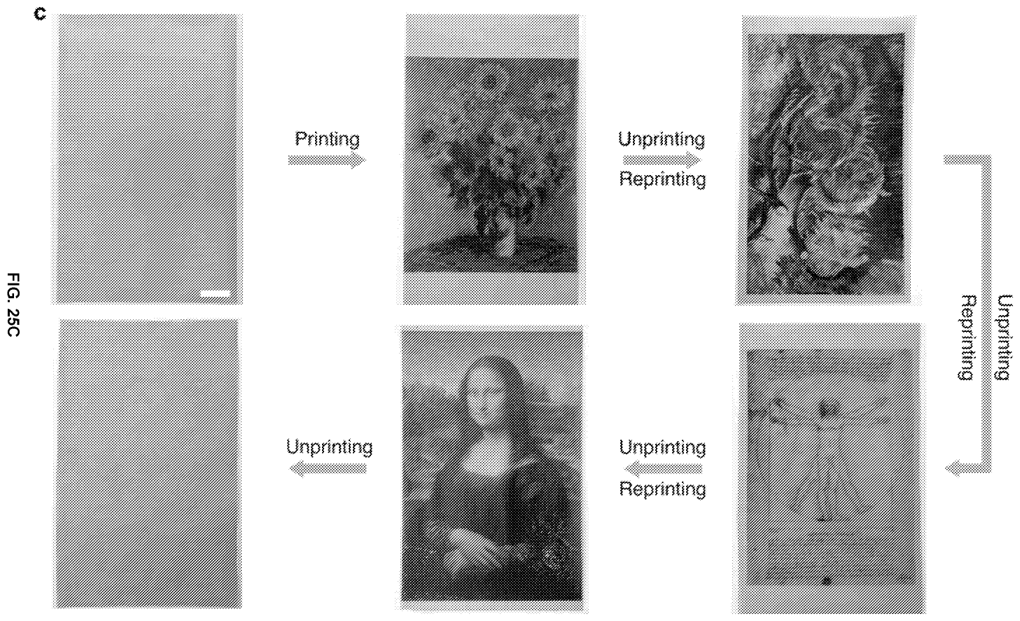

The pollen paper was subjected to multiple cycles of the acid-base treatment during the course of repeated printing and unprinting, and the swelling ratio at different junctures was measured (FIG. 25a). During the nine cycles, the pollen paper maintained a significant unidimensional swelling rate at ˜35% and shrunk back at the end of each cycle. Thus, the pollen paper maintained good reversibility in swelling and de-swelling between acidic and basic conditions, which indicates the possibility of long cycle lives of unprinting and reprinting. More significantly, its rough microtopography with featured spiky morphology of sunflower pollen was retained after nine cycles (FIG. 25b), ensuring the constant strong bond between the pollen paper and toner even after multiple rounds of recycling. Finally, we successfully demonstrated the repeated printing and unprinting of the same pollen paper with different pictures of various colors and patterns, as shown in FIG. 25c.

As a result, we could in-situ recycle the pollen paper in a non-destructive manner and reuse it for more printing cycles. This recyclable and reusable pollen paper demonstrates the potential for developing a wide range of sustainable information media products related to water-touch alarms, information security, and data protection, where the on-demand erasure of sensitive information is needed.

### Example 9. Recyclability of the Original Pollen Paper with Hydrophobic Toner Printed

Printing commercial hydrophobic toner on planar pollen paper (toner/pollen paper bilayer) The desired patterns were prepared using AutoCAD 2018. The toner (HP 76X High Yield Black Original LaserJet Toner) patterns were printed on the pollen paper prepared in Example 1 using a commercial laser printer (HP LaserJet Pro MFP M428fdn) at a resolution of 1200 dpi. The toner composition is shown in Table 3, according to the material safety data sheet (MSDS, Safety data sheet of hp laserjet cf276a-x-xc print cartridge, Hewlett-Packard, Boise, ID, USA, 2020).

TABLE 3
The black toner cartridge's chemical composition used in the
laser printer provided by the manufacturer (HP LaserJet Supplies).

| Chemical name | % Weight |
|---|---|
| Styrene acrylate copolymer | <50 |
| Iron oxide | <45 |
| Wax | <15 |
| Amorphous silica | <2 |

Recycling of the Pollen Paper Toner-printed original pollen paper was put into a DI water bath with mild agitation for 2 min to let the pollen paper fully swell. At the same time, the toner would fell apart and disperse into the water. Then, the swollen pollen paper was transferred into an ethanol bath for 5 min for contraction. At last, it was dried at the ambient environment to obtain the recycled pollen paper.

Results and Discussion

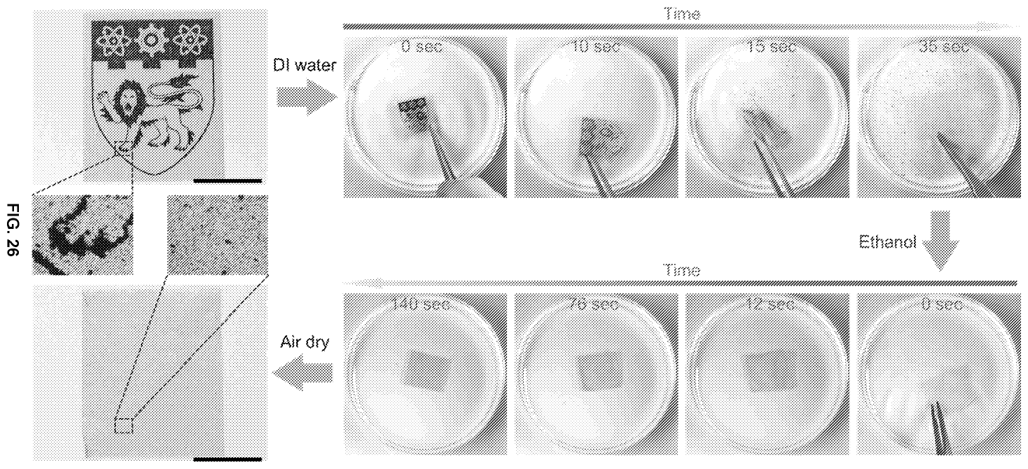

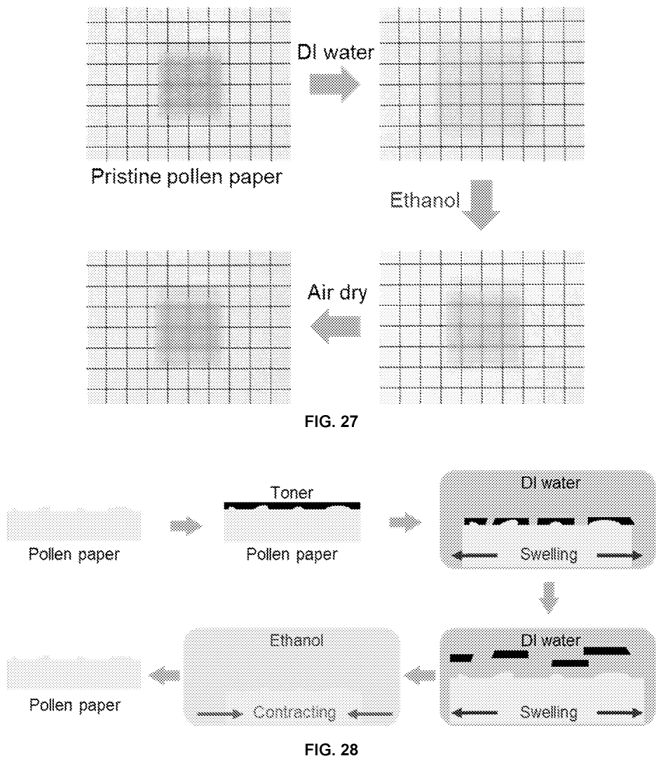

The complex toner patterns can be readily erased to recycle the pollen papers. FIG. 26 shows the reversal of the process whereby autonomous morphing induced by toner patterns could be erased in customized manner through a recycling process. After the toner-printed pollen paper was soaked in water, it dramatically swelled to increase its side length by around 50% (FIG. 27), which fractured the mechanical integrity of the toner layer. Consequently, the fragmented toner flakes gradually lost their adhesion to pollen paper and detached from the surface under agitation. More importantly, after subjecting to ethanol and air drying, the swollen pollen paper de-swelled back to its initial size (FIG. 27), successfully completing the recycling without any toner residues or net geometry changes. The whole process is schematically depicted in FIG. 28.

Therefore, the pollen paper can be completely recycled by erasing the printed patterns with water and ethanol thereby realizing reversible and reprogrammable hygromorphic configurations. This unique strategy, which combines easy-to-process pollen biomaterials of unique hygro-responsiveness with cost-effective digital printing, holds the promise for fabricating highly-controllable shape-morphing materials in a scalable and sustainable manner.

1. A method of recycling a pollen paper, comprising:
(a) providing a pollen paper that has been printed upon by a toner and/or an ink and immersing it in an aqueous solution having a pH of from 6 to 14 with mechanical agitation for a first period of time to remove the toner and/or ink and provide a swollen pollen paper;
(b) placing the swollen pollen paper into a dehydrating solvent for a second period of time to provide a dehydrated pollen paper; and
(c) subjecting the dehydrated pollen paper to an acidic solution for a third period of time and then drying it to provide a hygro-stable pollen paper suitable for use in a printer.

2. The method according to claim 1, wherein the aqueous solution is an alkaline solution.

3. The method according to claim 1, wherein the first period of time is from 10 seconds to 1 hour.

4. The method according to claim 1, wherein the dehydrating solvent is an alcohol.

5. The method according to claim 1, wherein the second period of time is from 10 seconds to 1 hour.

6. The method according to claim 1, wherein the pH of the acidic solution is from 1 to 5.

7. The method according to claim 1, wherein the third period of time is from 1 minute to 7 days.

8. The method according to claim 1, wherein the hygro-stable pollen paper shows a unidimensional swelling ratio of less than or equal to 5% when immersed in water having a pH of about 7 for 5 minutes.

9. The method according to claim 1, wherein after step (b) and before step (c) of claim 1, the pollen paper is dried to provide a dried pollen paper.

10. The method according to claim 1, wherein when the pollen paper provided in step (a) comprises a plurality of pollen microgels
and is a hygro-stable pollen paper, it shows a unidimensional swelling ratio of less than or equal to 5% when immersed in water having a pH of about 7 for 5 minutes.

11. The method according to claim 10, wherein when the pollen paper is a hygro-stable pollen paper, each of the plurality of pollen microgels has a surface that comprises a plurality of carboxylic acid functional groups, where substantially all of the carboxylic acid functional groups are in the protonated (CO₂H) form.

12. A hygro-stable pollen paper, comprising a plurality of pollen microgels, wherein the hygro-stable pollen paper shows a unidimensional swelling ratio of less than or equal to 5% when immersed in water having a pH of about 7 for 5 minutes.

13. The hygro-stable pollen paper according to claim 12, wherein each of the plurality of pollen microgels has a surface that comprises a plurality of carboxylic acid functional groups, where substantially all of the carboxylic acid functional groups are in the protonated (CO₂H) form.

14. A method of forming a hygro-stable pollen paper, the method comprising the steps of:
(ai) providing a pollen paper; and
(aii) subjecting the pollen paper to an acidic solution for a period of time and then drying it to provide a hygro-stable pollen paper.

15. The method according to claim 14, wherein the pH of the acidic solution is from 1 to 5.

16. The method according to claim 14 wherein the period of time is from 1 minute to 7 days.

17. The method according to claim 14, wherein the hygro-stable pollen paper shows a unidimensional swelling ratio of less than or equal to 5% when immersed in water having a pH of about 7 for 5 minutes.

18. The method according to claim 2, wherein the pH of the alkaline solution is from 9 to 14.

19. The method according to claim 4, wherein the alcohol is selected from one or more of the group consisting of methanol, ethanol, n-propanol, and i-propanol.

20. The method according to claim 1, wherein when the pollen paper provided in step (a) comprises a plurality of pollen microgels and is a hygro-instable pollen paper, it shows a unidimensional swelling ratio of greater than or equal to 25% when immersed in water having a pH of about 7 for 5 minutes.
